(19) United States
(12) Patent Application Publication
(10) Pub. No.: US 2007/0266246 A1
(43) Pub. Date: Nov. 15, 2007

(54) User authentication method and system for a home network

(75) Inventors: Yung-ji Lee, Suwon-si (KR); Kyung-hee Lee, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/819,052

(22) Filed: Jun. 25, 2007

Related U.S. Application Data
(62) Division of application No. 11/319,277, filed on Dec. 29, 2005.

(30) Foreign Application Priority Data
Dec. 30, 2004 (KR) 10-2004-0116300

(51) Int. Cl. H04L 9/00

(52) U.S. Cl. 713/168

(57) ABSTRACT

An external authentication method authenticates access a home network from outside the home network using temporal credential information. The method of authentication for the home network includes requesting a transmission of temporal credential information from the home server for authenticating a user, and receiving the temporal credential information from the home server. The temporal credential information is information including, for example, a temporal authentication key. Accordingly, the home user can access the home network by performing a facilitated and safer authentication using the temporal authentication key from outside the home network.

### CROSS-REFERENCE TO RELATED APPLICATIONS

This is a divisional of application Ser. No. 11/319,277 filed Dec. 29, 2005, the entire disclosure of which is considered part of the disclosure of the accompanying divisional application and is hereby incorporated by reference. This application claims priority under 35 U.S.C. §119 from Korean Patent Application No. 10-2004-0116300, filed on Dec. 30, 2004, in the Korean Intellectual Property Office, the entire content of which is incorporated herein by reference.

### BACKGROUND OF THE INVENTION

1. Field of the Invention

Methods consistent with the present invention relate to user authentication for a home network, and in particular, to external authentication which allows a home user to access the home network using a device that is outside the home network.

2. Description of the Related Art

A method capable of performing authentication of a device that is outside the home network can be achieved in several ways, such as a public key infrastructure (PKI) and an Internet Protocol (IP) layer Security Protocol (IPSec) based virtual private network.

The PKI is a complex security system environment which provides encryption and electronic signature through a public key algorithm. The PKI encodes transmitted data, decodes received data, and authenticates the user through a digital certificate, using a public key comprising an encoding key and a decoding key. Methods of encoding data in the PKI include an open key method and a secret key method. In accordance with the secret key method, the same secret key is shared by both a transmitter and a receiver, whereas, in accordance with the open key method, the encoding key and the decoding key are different, so that almost complete data security is possible and the probability of draining information is low.

The IPSec is a standard security protocol, which allows firewall vendors such as CHECKPOINT, RAPTOR SYSTEM, and so forth, to standardize various security methods for the security of a virtual private network so that interworking is possible.

The virtual private network allows even a user who does not have their own information communication network to use and manage a public data communication network as if the user had built their own communication network using the public data communication network. The virtual private network based on the IPSec is a better communication method which has improved upon the drawbacks of security.

However, both of these communication methods have problems in authenticating an external home user. In the case of the PKI, a PKI has good security but requires a large amount of computations to be applied because ta PKI employs a conventional certificate and, as such, it is quite complicated. In addition, both the PKI and the IPSec based virtual private network are carried out through a third server using an Internet Service Provider (ISP), which introduces limitations on security. Moreover, whenever a home user performs the authentication external to the home network, the user must remember the user's ID and password and directly input them, so that both the PKI and the IPSec based virtual private network are not authentication protocols which are suitable for external authentication for the home network environment because they require many interventions of the user.

### SUMMARY OF THE INVENTION

It is therefore an aspect of the present invention to provide an external authentication method which allows a home user to access a home network in a safe and facilitated way when using a device outside the home network.

Exemplary embodiments of the present invention overcome the disadvantages described above and other disadvantages not described above. Also, the present invention is not required to overcome the disadvantages described above, and an exemplary embodiment of the present invention may not overcome any of the problems described above.

According to one aspect of the present invention, there is provided a method of authentication for a home network, which includes: requesting a transmission of temporal credential information for authenticating a user from the home server; and receiving the temporal credential information from the home server. And, in this case, the temporal credential information includes a temporal authentication key.

According to another aspect of the present invention, there is provided a method of authentication for a home network, which includes: receiving an authentication initiation request and home server information for authenticating a user from a mobile device; transmitting relay device information to the mobile device; receiving user authentication data based on the relay device information from the mobile device; transmitting the user authentication data received from the mobile device to the home server; receiving user authentication information from the home server; transmitting the received user authentication information to the mobile device; receiving authentication validation information from the mobile device; and transmitting the received authentication validation information to the home server.

According to another aspect of the present invention, there is provided a method of authenticating for a home network, which includes: storing and maintaining temporal credential information received from a home server; transmitting a hash algorithm and a guest authentication key generated based on the temporal credential information to a guest device; and transmitting, to the home server, at least one of information about a guest authorization, including a guest ID of the guest device, accessible service information, and a hash algorithm.

According to another aspect of the present invention, there is provided a method of authenticating for a home network, which includes: receiving a guest authentication key and a hash algorithm from a mobile device; transmitting, to the mobile device, at least one of information about a guest authorization, including a guest ID, accessible service information, and the hash algorithm based on the received guest authentication key and the hash algorithm; transmitting the created guest authentication information to the home server; and receiving, from the home server, at least one of information about a home network state, including user accessible service information, and database state information.

According to another aspect of the present invention, there is provided a method of authenticating for a home network, which includes: storing and maintaining temporal credential information received from a home server; transmitting, to a guest device, at least one of information about guest authorization, including a guest authentication key for authenticating the guest device, and a hash algorithm; and transmitting, to the home server, a guest ID of the guest device, an accessible service information, and the hash algorithm.

According to another aspect of the present invention, there is provided an apparatus for authenticating for a home network, which includes: a unit storing and maintaining temporal credential information received from a home server; a unit transmitting an authentication initiation request and home server information to a relay device and receiving relay device information about the relay device; and an operation unit creating a guest authentication key for a user based on the temporal credential information.

### BRIEF DESCRIPTION OF THE DRAWINGS

The above and/or other aspects and features of the present invention will be more apparent by describing certain exemplary embodiments of the present invention with reference to the accompanying drawings, in which:

FIG. 1 is a view illustrating an example of receiving temporal credential information for user authentication from outside a home network in accordance with the an exemplary embodiment of the present invention;

FIG. 2 is a flow chart illustrating a method of authenticating a user using a relay device that is outside a home network in accordance with an exemplary embodiment of the present invention;

FIG. 3 is a view illustrating an exemplary embodiment of authenticating a user using a relay device that is outside a home network in accordance with the present invention;

FIG. 4 is a flow chart illustrating a method of authenticating a user using a guest device that is outside a home network in accordance with an exemplary embodiment of the present invention;

FIG. 5 is a view illustrating an exemplary embodiment of external authentication using a guest device in accordance with the present invention; and

FIG. 6 is a view illustrating a home network apparatus for external authentication in accordance with an exemplary embodiment of the present invention.

### DETAILED DESCRIPTION OF THE EXEMPLARY EMBODIMENTS OF THE INVENTION

Hereinafter, exemplary embodiments of the present invention will be described in detail with reference to accompanying drawings.

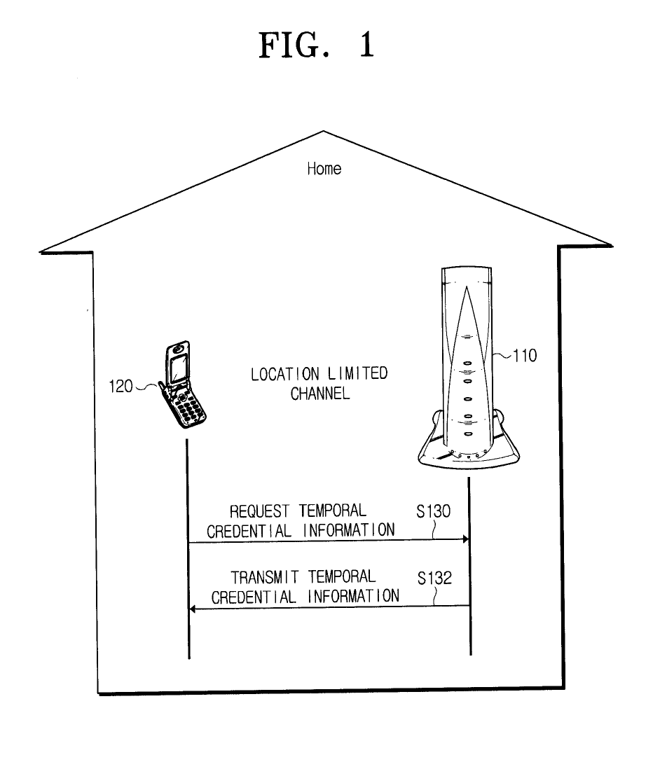

FIG. 1 is a view illustrating an example of receiving temporal credential information for user authentication from outside a home network in accordance with an exemplary embodiment of the present invention.

Before a user exits from a home network for going out of the home or the like, he requests from a home server 110, using a mobile device 120, that temporal credential information be transmitted (operation 130). Temporal credential information is authentication information which is temporary and which allows the user to be externally authenticated. The temporal credential information has a temporal authentication key, and the temporal authentication key is an authentication key capable of temporarily issuing a right to perform a safe external authentication of the user.

The temporal authentication key includes at least one of a user identification (ID), an issue time of the temporal authentication key, a lifetime of the temporal authentication key, an authorization level, and a hash algorithm.

The issue time of the temporal authentication key is a time at which the temporal authentication key is issued, and the lifetime of the temporal authentication key is a time during which the temporal authentication key is effective. The temporal authentication key is effective until the lifetime has elapsed from the issue time of the temporal authentication key as a reference starting time. In addition, when the user performs authentication from outside the home network, a time during which the user is allowed to access the home server 110 so as to exercise the user's influence over the home network after authentication of the user has been performed, may be limited. When a predetermined time has elapsed after the temporal authentication key was issued, the user cannot use the temporal credential information stored in the mobile device 120 and, therefore, the user cannot access the home server 110 using the expired temporal authentication key.

When the user accesses the home server 110, an access level of the user is also changed in response to the authorization level included in the temporal credential information. The home server 110 stores at least two items of temporal credential information, which have different authorization levels, and may transmit the items of temporal credential information, each having a different authorization level, to the mobile device 120. The user requests the temporal credential information from the home server 110, and the temporal credential information is transmitted to the mobile device 120 for authentication from outside the home network. In this case, the user can pre-establish a level of the authorization that is to be granted to the user outside the home network, wherein the authorization level is included in the temporal credential information beforehand. The user who is authenticated from outside the home network exercises the user's influence over the home network based on the magnitude of the authorization level included in the temporal credential information.

By way of example, a different access authorization level may be given to each member of a family. When the family consists of a member A and a member B, who live together, the authorization level of the temporal credential information can be adjusted such that the temporal credential information which is received by the member A can control all apparatuses within the home from outside the home network, whereas the temporal credential information received by the member B can only control some of the apparatuses within the home from outside the home network.

A hash algorithm is a necessary algorithm when the mobile device 120 of the user tries to access the home network from outside the home network, wherein the home network performs hashing on the temporal credential information, including the temporal authentication key, in order to prevent a replay attack of the relay device, and then transmits the temporal credential information. A replay attack refers to an act in which an unapproved user pretends to be a valid user by transmitting the temporal credential information to the home server 110 using a relay device when the unapproved user is not actually connected thereto. Such a replay attack may result in the unapproved user illegally connecting to the home server 110, which may present a serious danger. Accordingly, a hash algorithm must be used to encrypt and transmit the temporal credential information.

When the home server 110 receives the temporal credential information from the mobile device 120, the user may have previously set a user ID of the temporal credential information, a password, a time of issuing a temporal authentication key, and an authorization level, and may have previously requested the resultant temporal credential information. After the home server 100 receives such a request for resultant temporal credential information from a user, the home server 110 then transmits the temporal credential information suitable for the request received from the user, to the mobile device 120.

A procedure of allowing the user to receive the temporal credential information transmitted from the home server 110 to the mobile device 120 is carried out within the home, and is carried out through a location limited channel or a short range channel. Such channels are used for the sake of safety by making transmission of the temporal credential information occur within the user's range of vision. An example of such a location limited channel may include an Infrared Data Access (IrDA).

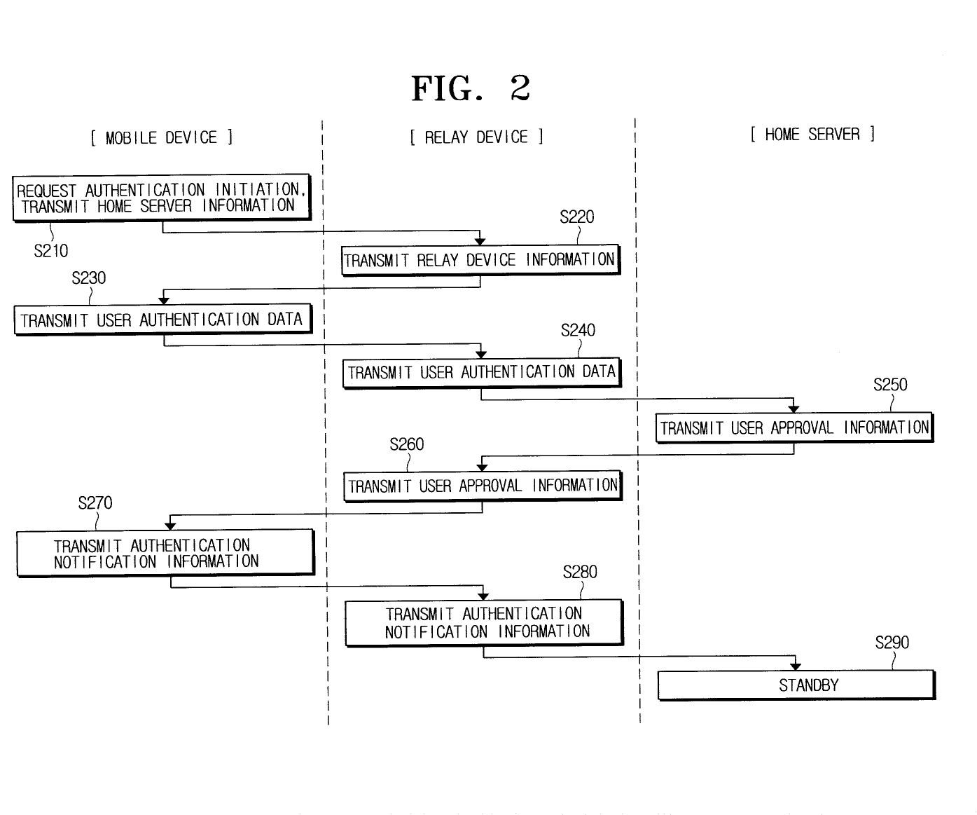

FIG. 2 is a flow chart illustrating a method of authenticating a user using a relay device outside a home network in accordance with an exemplary embodiment of the present invention.

Temporal credential information which has been received from the home server is stored in the mobile device of the user. The temporal credential information is authentication information which allows for temporary access to the home server and which allows for the issuance of an authorization when the user tries to access the home network from outside the home network. The temporal credential information is configured to have a temporal authentication key (TAK), a lifetime of the TAK, and a hash algorithm. The TAK is a value of the authentication key for accessing the home server, the lifetime is a substantially effective period of the TAK. Temporal credential information whose lifetime has elapsed loses its authorization so that a user attempting to use such temporal credential information cannot exercise the user's influence on the home server. The hash algorithm is an algorithm for hashing information transmitted to the home server or received from the home server. The temporal credential information can be stored using a memory mounted in the mobile device, and the user can be authenticated at any location using a portable device such as a cellular phone, a personal data assistant (PDA), a notebook computer, and so forth, as the mobile device. The user can have a mobile device, which has received the temporal credential information, and can exit the home network environment for going out of the home or the like.

In an operation S210, the user outside the home network accesses the relay device and transmits an external authentication initiation request and transmits home server information for accessing the home server. The relay device acts to perform a relay between the mobile device, which has the temporal credential information, and the home server. It is possible for a wide variety of communicative devices to access the home server, and any device that can access the home server and can perform predetermined communication with the home server can act as the relay device. For example, a cellular phone, a PDA, a desktop computer, a notebook computer, or the like, may all correspond to the relay device.

The external authentication initiation request means an act in which a message, which indicates that the user is using the temporal credential information of the mobile device from outside the home network to perform external authentication of the relay device is transmitted to the relay device. The home server information is information about the home server on which the user is trying to perform the external authentication. Such home server information is required because the relay device needs to receive information regarding the server on which the external authentication must be performed in order to access the corresponding home server.

In addition, the communication between the mobile device and the relay device is carried out through a location limited channel. Performing the communication between both the mobile device and the relay device using the location limited channel, as well as receiving, by the mobile device, the temporal credential information, through the location limited channel from the home server, results in such communication being carried out through an extremely limited location. Such a measure is intended to seek the safety of the home network by preventing information from being drained and by directing the user to directly monitor the communication between both devices.

Next, in an operation S220, the relay device recognizes the home server which the mobile device must access based on the external authentication initiation request and the home server information received from the mobile device, and then transmits relay device information to the mobile device as a response to the external authentication initiation request.

The relay device information is information about the relay device that needs to be connected to the home server. For instance, an Internet Protocol/Media Access Control (IP/MAC) address, a serial number, public key information, and so forth, may correspond to such relay device information. Authentication must be performed on the relay device carrying out a relay between the mobile device and the home server, as well as the mobile device having the temporal credential information, so that the user authentication can be completed and so that the user can externally transmit an instruction to the home network.

In the next operation S230, the mobile device that has received the relay device information transmits user authentication data to the relay device. The user authentication data is data which is for performing the user authentication from outside the home network, and which is information created based on the temporal credential information transmitted from the home server to the mobile device before the user exits the home network. The user authentication data may include, for example, a user ID, a lifetime of the TAK, a number of uses of the TAK, a time stamp, a challenge, and a hash algorithm.

The user ID is an item which is included in the temporal credential information, and the lifetime of the TAK is a period during which the TAK can be effective. The number of uses of the TAK is a number of instances when the TAK has been used, and the time stamp is data which records a point in time when the user authentication on the home server is performed. The challenge is a value transmitted from the mobile device to the relay device for mutual authentication.

In an operation S240, the relay device receives the user authentication data and accesses the home server that is retrieved based on the previously received home server information, and then transmits to the home server the user authentication data that is received from the mobile device.

In an operation S250, the home server performs authentication on the user authentication data, and then transmits its resultant user approval information to the relay device.

The home server receives the user authentication data from the relay device, and then checks whether the mobile device that has transmitted data through the relay device has already been registered in the home server.

In addition, the home server checks whether the user authentication data is created based on the temporal credential information issued by the home server. When the user authentication data is created based on the temporal credential information issued by the home server and when the mobile device has already been registered in the home server, the home server authenticates the user that has transmitted information through the relay device. When it is determined that the user is an invalid user, who is not registered in the home server, the home server can carry out disconnection to the relay device and the mobile device.

In an operation S260, the relay device transmits the user approval information that has been received from the home server to the mobile device.

In the next operation S270, the mobile device which has received the user approval information creates authentication notification information and transmits it to the relay device. The authentication notification information is a response to the user approval information that is transmitted from the home server, and the user transmits the authentication notification information from the mobile device to the relay device. The authentication notification information indicates that the mobile device and the relay device can transmit instructions from the user to the home server, so as to make the instructions executed at the same time when the authentication of the devices is completed on the home server.

In an operation S280, the relay device transmits the authentication notification information to the home server to complete an external authentication procedure. Further, in an operation S90, the home server receives the authentication notification information from the relay device and enters a standby mode in which it is capable of executing instructions from the user.

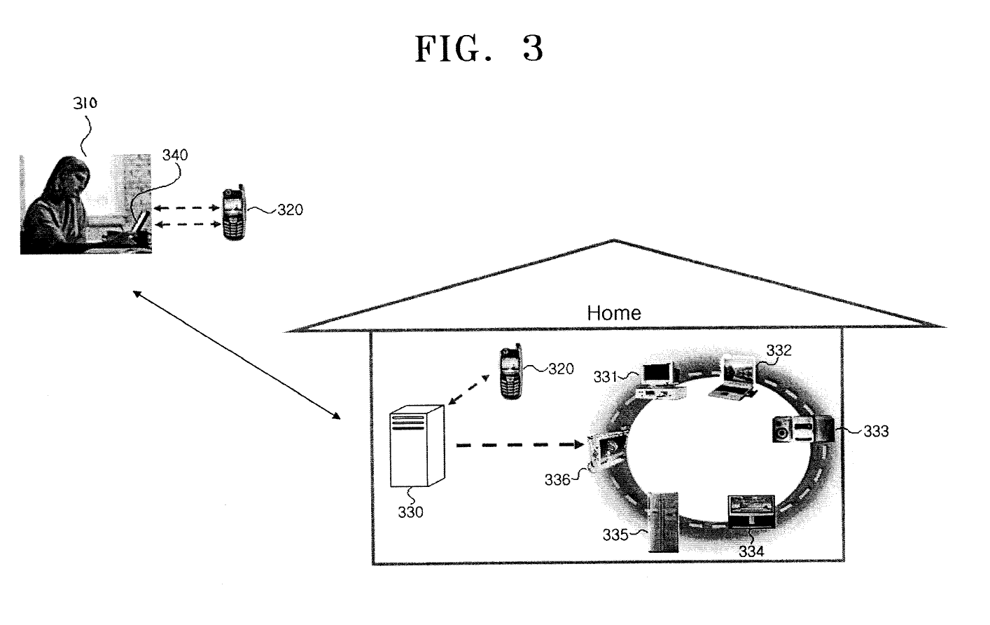

FIG. 3 is a view illustrating an exemplary embodiment of authenticating a user using a relay device outside a home network in accordance with the present invention.

First, the user 310 receives temporal credential information from the home server 330 to the cellular phone 320, which is a mobile device, before she goes out of the home. The user 310 goes out of the home with the cellular phone 320, in which the temporal credential information is stored. When the user 310 is located at a friend's home and needs to monitor the situation within the user's home, she uses the cellular phone 320 to transmit an authentication initiation request and home server information to the friend's notebook computer 340, which may serve as a relay device. The notebook computer 340 receives the authentication initiation request and the home server information from the cellular phone 320, and then transmits relay device information about the notebook computer 340 as its response.

Referring to FIG. 3, the relay device information comprises information about the friend's notebook 340.

The cellular phone 320 receives the relay device information and then transmits, to the notebook computer 340, user authentication data that is created based on the temporal credential information received from the home server 330 to the notebook computer 340. The user authentication data that is transmitted to the notebook computer 340 is then transmitted to the home server 330, which checks whether the received user authentication data are created based on the temporal credential information previously transmitted to the cellular phone 320. When it is determined that the user authentication data are created based on the temporal credential information previously transmitted from the home server 330 to the cellular phone 320, and the cellular phone 320 is a device that is registered in the home network 330, then the home network 330 transmits user approval information to the notebook computer 340.

The user approval information is information which indicates that the mobile device (e.g., the cellular phone 320) and the relay device (e.g., the notebook computer 340) are authenticated by the home server 330.

The user approval information transmitted to the notebook computer 340 is then transmitted to the cellular phone 320, which then transmits authentication notification information which notifies the authentication approval of the home server 330 to the notebook computer 340. The notebook computer 340 then transmits the authentication notification information to the home server 330, and the home server 330, which has received the authentication notification information, completes the authentication procedure accordingly and then enters in a standby mode, which allows the instructions of the user to be executed. Thus, the user 310 can monitor the situation within the home, from a friend's home, by accessing the home server 330.

The user 310 is connected to the home server 330 at a friend's home through the above-described authentication procedure so that the user can monitor the situation within the home.

By way of example, when the user 310 went out of the home to the friend's home, with the computer 332 being turned on, the user 310 first requests the home server 330 to check the current state of the computer 332. The home server 330 accepts the request of the user 310, collects information about the state of the computer 332, which is connected to the home server 330, and then transmits the collected information to the user 310. Since the user 310 went out of the home without turning off the computer 332, the home server will notify the user 310 that the computer 332 is turned on.

Furthermore, the user 310 can find out the respective states of all the devices that are connected to the home server 330 including, for example, computer 331, audio equipment 333, audio-visual equipment 334, refrigerator 335 and audio-visual equipment 336. When the user 310 tries to learn the current states of all the devices that are connected to the home server 330, the user 310 instructs this to the home server 330, which then instructs all the devices within the home to transmit information about the current states in a broadcast manner. The home server 330 then transmits the information collected from each of the devices within the home to the user 310, so that the user 310 can monitor the situation within the home from outside the home network.

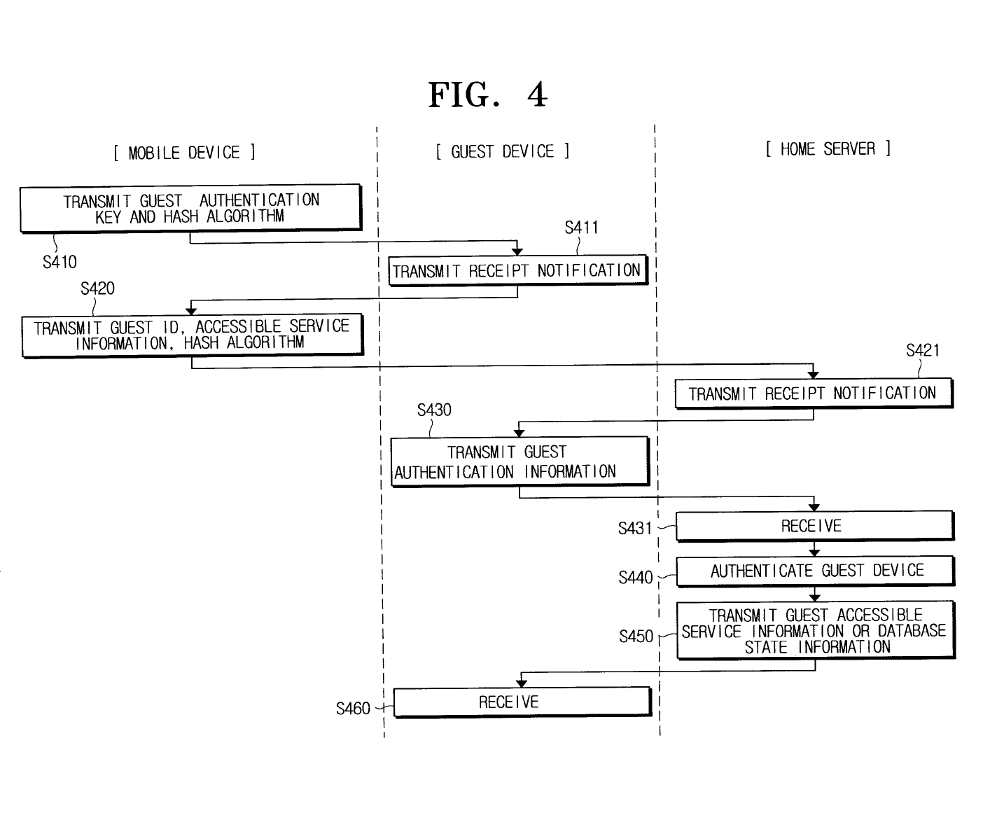

FIG. 4 is a flow chart illustrating a method of authenticating a user using a guest device outside a home network in accordance with an exemplary embodiment of the present invention.

Using the mobile device, the user requests that the temporal credential information be transmitted from the home server, and then the temporal credential information that is received from the home server is stored in the mobile device.

An external device is a device which is not registered with the home network. That is, an external device is a device which has no access authorization to the home network because it is not registered with the home network. Thus, when the user tries to access the home network using the external device from outside the home network due to going out of the home or the like, the external device being used by the user must be authenticated and the authorization from within the home network must be given. As such, an external device which can access the home server from outside the home network and which can exercise a predetermined authorization is referred to as a guest device.

First, in an operation S410, the user transmits a guest authentication key and a hash algorithm to the guest device using the mobile device. The home server does not allow access to an external device that is not registered in the home network. The guest device receives the guest authentication key from the mobile device, and then is authenticated by the home server. The guest device also receives the hash algorithm so that it can perform hashing on information that is received from the home server after authentication.

The guest authentication key that is stored in the mobile device and transmitted to the guest device is created based on the temporal credential information received from the home server by the user. The hash algorithm is received from the home server and is required to hash all information received from the home server. In addition, the corresponding mobile device becomes registered with the home server.

In the next operation S411, the guest device transmits a receipt notification message to the mobile device to notify the mobile device that the guest authentication key and the hash algorithm have been received.

In the next operation S420, the mobile device transmits, to the home server, a guest ID of the guest device, accessible service information, and a hash algorithm. The guest device is an external device which is not registered with the home network. However, the home network allows a connection between the guest device and the home server to be maintained, by allowing the user to notify the home server, when the corresponding guest device accesses the home server, that the user is connected to the home server using the guest device and by allowing the user to transmit information about the guest device to the home server. For instance, the home server requires information including the guest ID of the guest device, the accessible service information, and the hash algorithm.

The guest ID is an ID used by the guest device, and the accessible service information is information indicating that the access authorization of the guest device is limited by the user. The user can set the access limitations of the guest device in advance and can notify the home server of such access limitations. The home server, which has received the guest ID, the accessible service information, and the hash algorithm associated with the guest device, allows access to the external device having the guest ID received from the mobile device. In addition, the home server can refer to the accessible service information received from the mobile device to limit the authorization of the guest device on the home network so that it can limit the access of the external device. The hash algorithm associated with the guest device is the same as the hash algorithm received from the mobile device and is a function for carrying out decoding on the guest device.

In the next operation S421, the home server transmits a receipt notification message to the mobile device to notify the mobile device that the guest ID of the guest device, the accessible service information, and the hash algorithm have been received.

In the next operation S430, the guest device transmits the guest authentication information to the home server. In operation S431, the home server receives the transmitted guest authentication information. Further, in operation S440, the home server performs authentication on the guest device based on the transmitted guest authentication information. When the guest ID received from the mobile device does not match the guest ID received from the guest device, authentication is not carried out, and access to the home server by the guest device is rejected. The home server can authenticate the guest device and allow access to the home network only when the guest ID received from the mobile device matches the guest ID received from the guest device.

Even when authentication is permitted, the TAK is a secret value that is shared only between the mobile device and the home server. Accordingly, the authentication of the guest device is carried out using the guest TAK created by the mobile device instead of the TAK that is shared only between the mobile device and the home server. Further, the guest TAK is information which is limited to the guest device that is permitted to access the home server. The home server permits only the access range to the guest device that is set by the user in advance, and does so by referring to the accessible service information that is received from the mobile device. The guest TAK has a lifetime, a time stamp, and so forth, and the mobile device has the same, so that an access authorization to the home server can be temporarily exercised.

In the next operation S450, the home server transmits guest accessible service information or database state information to the authenticated guest device. The guest device can acquire the access authorization of the guest device within the home network by means of the received guest accessible service information or the database state information. The guest device can exercise its influence on the home network only within a range permitted by the home server, and cannot have any authorization outside that range. In addition, the guest accessible service information or the database state information that is transmitted to the guest device indicates that the home server is in a state capable of executing instructions by receiving such instructions from the guest device.

In operation S460, the guest device receives the guest accessible service information or database state information from the home server, and recognizes the access authorization that is granted at the home server. The guest device also recognizes that the home server is in a standby mode waiting for instructions to be transmitted from the guest device.

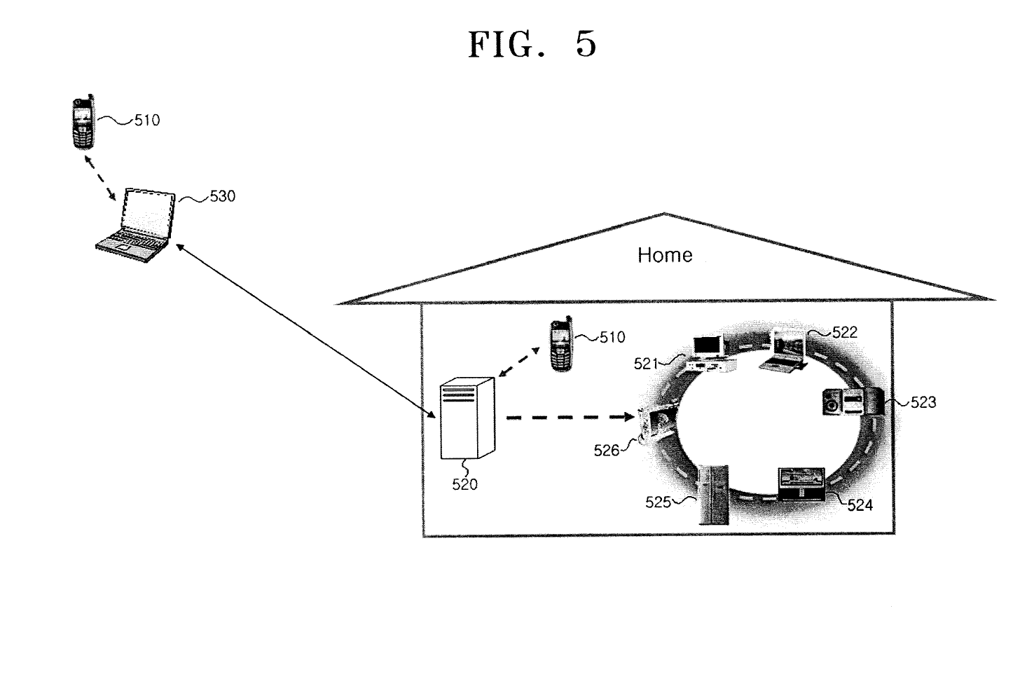

FIG. 5 is a view illustrating an exemplary embodiment of external authentication using a guest device in accordance with the present invention.

A home user A receives temporal credential information that is issued from the home server 520 to the cellular phone 510, which is a mobile device, before the home user A goes out of the home. Located within the home are devices including, for example, computer 522, audio equipment 523, audio-visual equipment 524, refrigerator 525 and audio-visual equipment 526

The user A then goes out of the home to a friend's home with a cellular phone 510, in which the temporal credential information is stored. By way of illustration, consider the situation where the user A wants to show moving picture data, that is stored in the computer 521 of the user A, to the friend B.

In such a situation, first, the user A sets the friend's notebook computer 530 as the guest device, which is capable of storing and reproducing the moving picture data. The user A then uses the temporal credential information that is stored in the cellular phone 510 to transmit the TAK of the guest device and the hash algorithm. The user A then uses the mobile device 510 to transmit, to the home server 520, when the guest device 530 accesses the home server 520, the guest ID, the accessible service information, and the hash algorithm.

When the user A sets an ID of the friend's notebook computer 530 to “Friend B,” then the guest ID of the notebook computer 530 becomes the “Friend B.” Further, when the user A sets the notebook computer 530 of the friend B such that it is granted access only to the computer 521 of the user A within the home, then the accessible service information of the notebook computer 530 indicates that the access range of the notebook computer 530 is limited to the computer 521.

Next, the user makes the notebook computer 530 transmit the guest authentication information to the home server 520 so that the home server 520 authenticates the notebook computer 530. Thus, the notebook computer 530 transmits the guest authentication information, including the guest ID previously set by the user and the guest TAK, and so forth, and the home server 520 examines the transmitted guest authentication information to determine whether the notebook computer 530 that is trying to access the home server 520 is safe. The guest authentication information is created by the notebook computer 530 based on the guest ID, the guest TAK, the hash algorithm, and so forth. When, after authenticating the guest authentication information, it is determined that the notebook computer 530 is safe the home server 520 authenticates the notebook computer 530, and notifies the user that the notebook computer 530 has been authenticated by transmitting the guest accessible service information or the database state information.

The user A transmits the guest authentication key, which includes the guest ID “friend B” and the hash algorithm, to the notebook computer 530 of the friend B. Thus, the guest authentication key becomes authentication information for the notebook computer 530. The guest authentication key is a key value that is operated based on the temporal credential information stored in the cellular phone 510 of the user A.

The user then uses the cellular phone 510 to transmit, to the home server, the guest ID for the notebook computer 530 of the friend B, the accessible service information, and the hash algorithm. The guest authentication information is then transmitted from the notebook computer 530 of the friend B to the home server 520. The home server 520 then authenticates the guest authentication information to permit access to the notebook computer 530, and transmits the guest accessible service information or the database state information to the notebook computer 530, thereby making clear the access authorization of the notebook computer 530 and notifying the notebook computer 530 of the completion of the authentication.

When the authentication is completed, the user A may access the home server 520 and may use the notebook computer 530, for example, to request the home server that the moving picture that is stored in the computer 521 be transmitted to the notebook computer 530 of the friend B. In such a case, the home server 520 receives the instruction of the user A, through the notebook computer 530 of the friend B, and transmits the moving picture that is stored in the computer 521 of the user A to the notebook computer 530 of the friend B. When the moving picture is completely transmitted to the notebook computer 530, the user A can show the friend B the moving picture that he has tried to play.

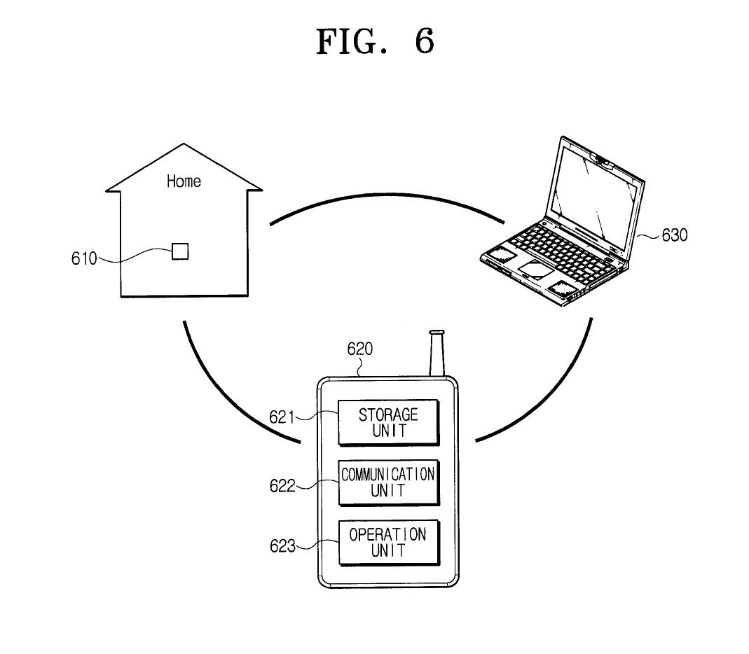

FIG. 6 is a view illustrating a home network apparatus for external authentication in accordance with an exemplary embodiment of the present invention. The home server 610 issues temporal credential information to the mobile device 620, and the mobile device 620 receives the temporal credential information so that the authentication to the home server 610 can be carried out from outside. The relay device 630 acts to relay data between the mobile device 620 and the home server 610, so that the user can perform the authentication to the home server 610 and allows instructions of the user to be transmitted to the home network.

The mobile device 620 is configured to have a storage unit 621, a communication unit 622, and an operation unit 623. The storage unit 621 stores the temporal credential information and the home server information received from the home server 610. The communication unit 622 requests data transmission to the home server 610 and the relay device 630 or receives data therefrom, and the operation unit 623 performs operations that may occur during the authentication procedure. The operation unit 623 operates the user authentication data based on the relay device information that is received from the relay device 630. In addition, the operation unit 623 operates the guest TAK based on the temporal credential information that is received from the home server 610 for authentication of the guest device. The TAK is a secret value, which is shared only between the home server 610 and the mobile device 620, so that the guest device cannot have the TAK. The mobile device 620 instead operates the guest TAK value and gives it to the guest device, and the guest TAK is based on the temporal credential information for authenticating the guest device. Operations for the user authentication data or the guest TAK value are carried out with information of each of the respective devices being reflected.

According to the exemplary embodiments of the present invention as described above, an authentication method and an authentication apparatus are provided which have enhanced safety and which are facilitated to be used by the home user who is using the TAK from outside the home network.

The TAK received from the home server is made to be stored in the mobile device, which the user generally carries with him, so that the user can perform authentication regardless of the user's location.

The mobile device and the relay device are authenticated together so that the user and the external device can be authenticated together, and so that the temporal credential information received from the home server can be used for authentication so that a mutual authentication between the user and the home server can be implemented.

The user and the external device, which is used by the user, can be authenticated from outside the home network regardless of a separate server and the conventional infrastructure. Further, the temporal credential information received by the mobile device from the home server beforehand can be used, so that an authentication mechanism having less intervention of the user can be implemented.

The foregoing exemplary embodiments and advantages are merely exemplary and are not to be construed as limiting the present invention. The present teachings can be readily applied to other types of apparatuses. Also, the description of the exemplary embodiments of the present invention is intended to be illustrative, and not to limit the scope of the claims, and many alternatives, modifications, and variations will be apparent to those skilled in the art, without departing from the spirit and scope of the embodiments of the present invention as defined in the following claims.

What is claimed is:

1. A method of authentication for home network, the method comprising:
storing and maintaining temporal credential information received from a home server;
transmitting, to a guest device, a hash algorithm and a guest authentication key which is generated based on the temporal credential information; and
transmitting, to the home server, at least one of a guest identification (ID) of the guest device, accessible service information, and a hash algorithm.

2. The method according to claim 1, wherein transmitting the guest authentication key and the hash algorithm is carried out through a location limited channel.

3. A method of authentication for a home network, the method comprising:
receiving a guest authentication key and a hash algorithm from a mobile device which transmits, to the home server, at least one of a guest identification (ID), accessible service information, and the hash algorithm;
transmitting guest authentication information to the home server; and
receiving, from the home server, at least one of user accessible service information and database state information.

4. A method of authentication for a home network, the method comprising:
storing and maintaining temporal credential information received from a home server;
transmitting, to a guest device, a guest authentication key for authenticating the guest device, and a hash algorithm; and
transmitting, to the home server, a guest identification (ID) of the guest device, an accessible service information, and the hash algorithm.
